(19) United States
(12) Patent Application Publication
(10) Pub. No.: US 2026/0237257 A1
(43) Pub. Date: Aug. 13, 2026

(54) Vehicle Diagnosis and Service Arrangement and Vehicle Diagnosis and Service Method

(71) Applicant: Bayerische Motoren Werke Aktiengesellschaft, Muenchen (DE)

(72) Inventor: Christian LEMKEMEYER, Muenchen (DE)

(21) Appl. No.: 19/531,887

(22) Filed: Feb. 6, 2026

(30) Foreign Application Priority Data
Feb. 7, 2025 (DE) 10 2025 104 626.3

(51) Int. Cl. G07C 5/08; G06F 21/44; G07C 5/00; H04L 9/40

(52) U.S. Cl. CPC G07C 5/0858; G06F 21/44; G07C 5/008; H04L 63/166

(57) ABSTRACT

A vehicle diagnosis and service arrangement includes a vehicle having a USB interface, which is formed on an outside of the vehicle and is designed to transfer data between the vehicle and a workshop device, wherein the workshop device is connectable to the USB interface of the vehicle, and a digital key device, which is designed to authenticate a workshop device connected to the USB interface. The vehicle is designed, after successful authentication, to provide data for diagnostic purposes and/or software updates via the USB interface. A vehicle diagnosis and service method are also provided.

### CROSS REFERENCE TO RELATED APPLICATION

This application claims priority under 35 U.S.C. §119 from German Patent Application No. 10 2025 104 626.3, filed February 7, 2025, the entire disclosure of which is herein expressly incorporated by reference.

### BACKGROUND AND SUMMARY

The present invention relates to a vehicle diagnosis and service arrangement and a vehicle diagnosis and service method.

Vehicles are presently increasingly being equipped with complex electronic systems, the maintenance and updating of which requires a regular readout of diagnostic data and installing new software. For example, these data are accessed via vehicle-internal interfaces, such as OBD ports. It is often necessary for this purpose to unlock the vehicle and establish a physical access to the interior. This not only can cause practical difficulties, for example, due to keeping doors or windows open during the workshop operation, but can also result in damage to the laid cables when the vehicle is moved or manipulated. In addition, the access to diagnostic ports often requires the authorization of sensitive vehicle functions, which can result in security gaps without a suitable authentication technology. The existing methods are therefore susceptible to practical handling problems, increased safety risks, and unnecessary expenditures in vehicle maintenance and repair.

One object of the present invention can be considered that of providing an improved vehicle diagnosis and service arrangement and an improved vehicle diagnosis and service method.

This object is achieved by a vehicle diagnosis and service arrangement and by a vehicle diagnosis and service method having the features of the claims.

The following is provided according to the invention:

A vehicle diagnosis and service arrangement, comprising a vehicle having a USB interface, which is formed in particular on an outside of the vehicle and is designed to transfer data between the vehicle and a workshop device, a workshop device which is designed to be connectable to the USB interface of the vehicle, and a digital key device which is designed to authenticate a workshop device connected to the USB interface, wherein the vehicle is designed to provide data for diagnostic purposes and/or software updates after successful authentication via the USB interface.

Furthermore, a vehicle diagnosis and service method for carrying out diagnosis or service orders on a vehicle is provided, comprising the following steps: providing a vehicle having a USB interface, which is formed in particular on an outside of the vehicle, connecting a workshop device to the USB interface, authenticating the workshop device connected to the USB interface by means of a digital key device, providing data for diagnostic purposes and/or software updates from the vehicle to the workshop device via the USB interface after successful authentication by means of the digital key device.

The vehicle diagnosis and service arrangement comprises a vehicle which is equipped with an exterior USB interface, which is provided in particular on an outside of the vehicle, and via which a dataflow between the vehicle and an external workshop device is enabled. The USB interface is conceived so that the workshop device can be connected directly and physically to the vehicle. This vehicle diagnosis and service arrangement provides a direct, wired contact point. The USB interface thus forms the technical basis for an efficient transfer of diagnostic data or software updates, since it is usable without additional adapters or bypasses.

The workshop device is designed as an independent unit for the purpose of being connected to the USB interface of the vehicle. It can be designed so that it has common USB standards, which ensure a secure and stable data connection to the vehicle. Different technical variants, such as robust plug connections protected from environmental influences or particularly long-lived, mechanically loadable USB cables can be used here. In particular, it is directed to the workshop device being able to be coupled on and decoupled again easily in order to assist a flexible and time-efficient maintenance process.

The digital key device takes over the task of checking the workshop device connected to the USB interface with respect to its authorization. Various technical designs can be used for this purpose, for example, the use of cryptographic methods in order to ensure that only previously authorized workshop devices receive access to vehicle data. This authentication can take place on the software side in that, for example, unique digital keys, certificates, or signatures are exchanged, which are provided by the digital key device. Alternatively or additionally, it is conceivable that the digital key device is designed to be particularly secure from manipulation in its hardware embodiment in order to prevent unauthorized emulation of the key. The level of security can be increased significantly using such a solution, since the vehicle data are no longer generally freely accessible, but rather are output exclusively after positive authentication result.

The digital key device in the meaning of the present invention is a technical device which comprises both a physical, hardware-based component for the secure storage and processing of data and also the cryptographically protected authentication data themselves, in particular data of the digital key. The digital key device is designed in particular to provide authorization information for the access to vehicle data or vehicle functions – here in particular to diagnosis and/or service functions via a USB interface arranged on the vehicle.

The digital key device can be implemented here in the form of a CCC digital key module or a comparable device. It unifies two main aspects: on the one hand, the cryptographically encrypted data, in particular the data of a digital key, for example, in the form of private and public keys, certificates, or tokens, on the other hand, the physical technical device for the secure storage and use thereof. A digital key represents an authorization which in particular enables a vehicle to be used and/or in particular enables the vehicle to be accessed for diagnosis, service, or software update purposes without unauthorized third parties receiving access or manipulation possibilities.

An essential feature of this digital key device is its secure hardware environment, for example, a secure element (SE), in which, for example, the digital keys and/or certificates are stored. This secure element is a specially protected hardware component which obstructs attacks on the software and hardware level and thus ensures the integrity and confidentiality of the authentication data. The data stored in the digital key device form the core of the digital key, since they contain the actual authorization information for the access to diagnosis or service functions present in the vehicle.

In addition, the digital key device is capable as a physical technical device of managing these data and providing them if needed for the authentication. This can take place, for example, in a mobile terminal, or a special workshop device. These devices can interact with the vehicle or the workshop infrastructure via corresponding communication interfaces (e.g., USB, Bluetooth, Wi-Fi, NFC, and/or UWB), in order to transmit the authorization information and thus enable the access to vehicle data. In the present invention, the USB interface is mentioned in particular, which is arranged, for example, on the outside or in the interior of the vehicle and enables the diagnosis and service access to the vehicle.

Additionally to the cryptographic authentication data, the digital key device can store further relevant information. This includes, for example, usage restrictions, temporal validities, and event -related releases of authorization information. Augmented data such as vehicle states (for example, battery state of charge) or metadata about earlier diagnosis and service work can also be stored. This enables an accurate, flexible, and secure control of the data access in the context of maintenance and service processes.

In particular, the digital key device is designed according to the CCC specifications according to Release 3.0 or higher. The digital key device can in particular enable a passive and location-based interaction with the vehicle and/or the workshop device. This concept can be transferred in the present invention to the field of vehicle diagnosis and maintenance: the digital key device ensures that only authorized workshop devices, which are located in direct proximity and have the correct authorizations, receive access to sensitive vehicle data.

The security of the communication processes is ensured here both by the physical safeguarding of the secure element and also by modern encryption and signature methods. The exchange of authorization information between digital key device, vehicle, and possibly a secure cloud infrastructure or a vehicle owner app take place via protected channels. This ensures that unauthorized access to the diagnosis and service functions of the vehicle cannot take place.

Overall, the digital key device therefore represents a central security and control instance, which secures the access and authorization process to vehicle diagnosis and surface functions and makes it flexibly controllable. It is therefore an essential component of the vehicle diagnosis and service arrangement according to the invention, which ensures the reliable, manipulation-proof, and efficient access to vehicle data and software updates via a USB interface attached to the outside of the vehicle.

As soon as the authentication has been successful, the vehicle provides the requested data for diagnostic purposes and/or software updates via the USB interface. The technical design is applied here so that after successful checking of the authorization, a defined data interface is unlocked, via which the workshop device can access the relevant, previously configured diagnosis information or update files. The design can be such that a special communication module exists within the vehicle network, which prepares the data in a suitable manner and forwards these data to the workshop device in order to be able to carry out the desired maintenance or update order efficiently.

The direct access via a standardized USB interface enables simplified workflows, since the workshop personnel do not have to deal with obstructed access conditions or complex adapter solutions. At the same time, it is ensured by the digital authentication that only authorized devices receive relevant data. This protects from undesired access, enhances the data security, and ensures that sensitive information does not reach the wrong hands. Moreover, service processes can be made more efficient and cost-effective, since time and material expenditure for establishing the access and securing the data accesses are reduced.

Furthermore, the present invention provides a vehicle diagnosis and service method, in which first a vehicle is provided which is provided with a USB interface. This USB interface, which is provided in particular on an outer side of the vehicle, is used as a defined access point in order to exchange data between the vehicle and an external workshop device. It can be technically embodied so that it is reliable, stable, and protected from external influences. This ensures that the subsequent connection procedure of the workshop device can take place without a time-intensive search for internal ports and/or in particular without opening the vehicle.

In the next step, the workshop device is connected to the USB interface. This procedure can be practically designed so that a corresponding plug is simply plugged into the provided socket on the vehicle. Technical embodiments can be a rugged USB standard port here, which is optimized especially for rough workshop environments. The workshop device itself can adopt greatly varying forms, such as a robust diagnostic computer or a compact testing and programming module.

This is followed by the authentication of the connected workshop device by means of a digital key device. This step is a central aspect of the method, since it defines whether and which data the vehicle releases after completed checking. Viewed technically, the digital key device can operate, inter alia, via cryptographic keys, encrypted certificates, or signatures in order to prevent manipulations and ensure that only authorized devices, such as those of an officially authorized workshop, receive access to the vehicle data. It is conceivable that various communication protocols are used for this purpose in order to meet the security requirements and ensure a rapid and unambiguous identification.

The vehicle only provides its diagnostic data and/or software updates to the workshop device via the USB interface after successful authentication. This can be technically achieved so that the vehicle-internal network unlocks the USB interface, via which all relevant data streams flow unobstructed, after a positive check of the access right. In this case, for example, current error memories can be output, vehicle configurations can be adjusted, and/or software modules can be updated. Technical embodiments extend from standardized protocols for exchanging diagnostic parameters to highly-specialized methods for software updates, for example, to expand vehicle functions or install safety-critical patches.

The technical advantages of the method described are in the significant simplification of diagnostic and service work. In that the vehicle is equipped with a USB interface, cumbersome accesses to internal connection points are eliminated, which accelerates the process and minimizes work steps. Moreover, the digital authentication noticeably enhances the security, since only authorized workshop devices receive access to sensitive data. This reduces the risk of misuse or undesired manipulation. In addition, the simplified structure of the method contributes to making the maintenance process more cost-efficient, comfortable, and reliable overall.

According to a further preferred embodiment, the digital key device can be designed to provide the authentication of the workshop device using a CCC digital key protocol. The embodiment provides that the digital key device is designed so that it uses a CCC digital key protocol for the authentication of the workshop device. This form of the protocol is based on an accepted standard, which is widespread in particular with vehicle producers and is capable of providing a secure and unambiguous proof of identity for authorized devices. In technical terms, asymmetrical encryption methods, secure key derivatives, and cryptographic signatures can be used for this purpose in order to prevent unauthorized accesses or manipulation attempts. The digital key device ensures here that only those workshop devices receive an authorization which were able to be validated by means of the CCC digital key protocol. This means that, for example, every key can be uniquely linked with specific authorization profiles, usage limits, or time restrictions. Different hardware or software implementations come into consideration for the design, such as special cryptographic chips integrated into the vehicle or also secure software modules, which are executed in a secured environment. In addition, the protocol sequences can be adapted flexibly to various security levels and developing standards in order to ensure a high level of protection at all times. Accesses to the data stored in the vehicle can be accurately regulated by the use of this protocol, which represents a central technical improvement in relation to less differentiated authentication methods. In particular, the integrity of the overall diagnosis and service process is substantially enhanced, since the method ensures automatically that only verified devices receive the relevant vehicle data. This contributes to increasing the service quality, avoiding the misuse of access rights, and increasing the safety and reliability of vehicle diagnosis and maintenance in the long term.

According to a further preferred embodiment, the USB interface can be designed as a USB-C interface. The embodiment provides that the USB interface is designed as a USB-C interface in order to be able to use a particularly flexible and future-oriented connection standard. Technically, this enables a high data transfer rate and the possibility of also making energy transfer efficient, in addition to data communication alone. The USB-C specification provides a symmetrical plug, which functions independently of its plug-in direction and thus reduces operating errors to a minimum. The connected workshop device can be connected more easily, faster, and more securely to the vehicle by this design, since no complex adapter solutions or additional orientation aids are necessary. In addition, USB-C is an economically attractive standard with regard to its robust contacts and its broad distribution in many branches.

According to a further preferred embodiment, the USB interface can be designed to provide a maintenance charge of the vehicle battery. The embodiment provides that the USB interface is designed so that, in addition to the data exchange, it can also provide a maintenance charge of the vehicle battery. This means that the interface is used not only solely for communication between vehicle and workshop device, but rather at the same time functions as a power source in order to continuously supply the battery with a low charging current. This can be technically implemented in that the USB interface is specified accordingly, in order to also guide separate energy supply lines having a defined amperage and voltage in addition to the data lines. In this way, the electrical parameters can be set so that the state of charge of the battery is kept stable without overloading or damaging it. The advantages are that longer work on the vehicle is possible without the battery being discharged by the demands of the vehicle electrical system. More extensive diagnosis processes, software updates, and calibrations can thus be carried out without running the risk of a voltage drop in the system. This design moreover increases the reliability of the maintenance work, since it is ensured that the vehicle always has sufficient reserve energy to maintain critical functions. In addition, the service is simplified because no separate battery charger or additional connections are required to ensure the energy supply during longer diagnosis or update processes.

According to a further preferred embodiment, the digital key device can be designed as a CCC digital key module. The embodiment provides that the digital key device is designed as a CCC digital key module, which means that it is based on a uniform standard specified by the Car Connectivity Consortium (CCC). This enables interoperability between different producers and devices, since a CCC digital key module can be integrated seamlessly into common vehicle and workshop environments. Viewed technically, such a module can use protected keys, certificates, and cryptographic algorithms on the hardware side in order to carry out a particularly trustworthy authentication. This standardized interface also offers advantages on the software level, such as a simpler implementation of security updates or protocol changes. The entire solution becomes more future-proof due to this standardization, since new developments in the field of digital vehicle keys can be integrated without fundamental system changes. The handling is also facilitated for the workshop, since known and proven routines can be used. Overall, this design increases the reliability, compatibility, and security of the entire diagnosis and service process, since it builds on established and widely distributed technology standards.

According to a further preferred embodiment, the digital key device can have a wireless communication interface. The embodiment provides that the digital key device has a wireless communication interface. This means that the authentication of the workshop device does not necessarily have to take place via a physical connection, but can also take place wirelessly. Various standards such as Bluetooth and/or Wi-Fi and/or NFC can technically be used for this purpose. Such a wireless interface enables the digital key device to be used flexibly, for example, also from a mobile device or another remote device.

The wireless communication can be designed so that it is based on secure protocols which ensure encrypted data transfer and authentication. Security measures such as pairing processes, one-time tokens, or time-limited authorizations could be implemented here in order to prevent unauthorized access. The digital key device can also be conceived so that it automatically identifies wireless connections and initiates an authentication request as soon as an authorized workshop device is in range.

The advantage of this wireless design is the increased user-friendliness and flexibility. Workshop employees do not necessarily have to establish a physical connection, which makes the diagnosis and maintenance faster and more convenient. At the same time, wireless interfaces can enable a higher level of mobility, for example, if mobile terminals are used for authentication or in the case of remote maintenance. The service process becomes more efficient due to the wireless communication and new options open up for innovative applications, such as integration into cloud-based systems or real-time synchronization with other workshop resources.

According to a further preferred embodiment, the digital key device can be designed to provide authentication software. The embodiment provides that the digital key device is designed so that it can provide authentication software. This means that the functionality for authentication is not based exclusively on hardware, but rather is supplemented or implemented completely by special software. This authentication software can be executed on the workshop device, within the digital key device itself, or in a connected infrastructure.

The software can technically be designed so that it exchanges encrypted data, checks digital certificates, or generates keys which are required for the authentication of the workshop device. In addition, it could be updated regularly in order to be able to react to new security requirements or potential weak points. Such software could moreover be capable of managing dynamic authorizations which are, for example, time-limited or bound to specific usage contexts.

The provision of authentication software enables a high level of flexibility, since different systems and requirements can be addressed by software adaptations without the hardware having to be modified. Moreover, additional security features such as multifactor authentication, behavior analyses, or cryptographic updates can be integrated. The advantage of this embodiment is the expandability and adaptability of the digital key device, since the software solutions can be continuously refined in order to meet the requirements of modern security standards. At the same time, it increases the user-friendliness, since software updates can be distributed easily via central systems, which reduces the maintenance effort for the digital key device.

According to a further preferred embodiment, the digital key device can have a physical interface for connection to an external device, in particular the workshop device. The embodiment provides that the digital key device has a physical interface for connection to an external device. The physical interface could be technically embodied in the form of USB, ethernet, serial ports, or proprietary plug connectors, which ensure a secure and reliable data transfer.

A physical interface offers the advantage that the digital key device can be used independently of wireless communication standards or environmental conditions such as interfering signals. Moreover, it enables a robust connection which is proven in particular in workshop environments, in which physical interference or high security requirements can exist.

The direct connection to an external device ensures a secure authentication without possible wireless security risks. In addition, physical interfaces can be designed so that they also provide a power supply for the digital key device, due to which they are independent of internal batteries or other energy sources. This technical design moreover enables the use in environments in which wireless communication is not allowed or practical, for example, in sensitive security zones or shielded spaces.

According to a further preferred embodiment, the workshop device itself can comprise a digital key device, which is designed to provide authorization information for authentication with the vehicle. This means in particular that the authentication functionality is integrated directly into the workshop device instead of using a separate digital key device. The authorization information could be stored and managed in the workshop device in the form of digital keys, certificates, and/or other cryptographic data.

The digital key device can be technically implemented within the workshop device either as a hardware component, such as a secure cryptographic processor, or as a software module. This unit could transmit encrypted data to the vehicle in order to carry out a secure authentication. Moreover, it could be provided with regular updates in order to ensure security standards and support new vehicle types or diagnosis protocols.

The handling is simplified by the integration of the digital key device into the workshop device, since no additional hardware is required. This reduces the effort and the costs for the workshop, since all required functions are combined in a single device. Moreover, this design enables a seamless interaction between workshop device and vehicle, since the authentication information can be provided directly from the device without a separate authentication process via an external interface being necessary.

A further advantage of this integration is the enhanced security, since the authorization information is stored directly in the workshop device and does not have to be transferred via external channels, which reduces potential attack points. The technical simplification and the improved security make this embodiment particularly attractive for workshops which rely on efficiency and robust systems. At the same time, the operation is facilitated, since no additional devices or steps are necessary for the authentication.

According to a further preferred embodiment, the digital key device can have an encryption component, which is designed to provide the security of the data transfer. This component is used to protect the exchanged data between the digital key device and the vehicle and/or a workshop device, in that it encrypts the data and therefore secures the data from unauthorized access or manipulation.

The encryption component can be technically based on various technologies, for example, on asymmetrical cryptography systems such as RSA or ECC (Elliptic Curve Cryptography) or symmetrical encryption methods such as AES (Advanced Encryption Standard). The selection of the encryption method depends on the specific requirements for the security, the computing power, and the speed of the data transfer. One possible implementation could also include a combination of symmetrical and asymmetrical methods in order to make the key transfer process more secure.

The encryption component could be embodied in the digital key device either as a dedicated hardware chip (such as a Hardware Security Module, HSM) or as a software-based module within a protected environment. Hardware-based solutions offer the advantage of a particularly high level of security, since they are especially designed for cryptographic processing and can be protected from physical attacks. Software-based solutions, in contrast, enable greater flexibility and easier updating in the event of changing requirements.

The advantage of this embodiment is the significant enhancement of the data security during the authentication and the data transfer. Both the integrity and the trustworthiness of the transferred information are ensured by the encryption, so that potential attackers do not have a possibility of capturing or manipulating the data. This is particularly important with sensitive data such as vehicle diagnostic information or authorization messages, which could be misused.

According to a further preferred embodiment, the digital key device can be equipped with at least one of the following interfaces: Bluetooth, in particular BLE, and/or UWB, and/or Wi-Fi and/or NFC. These interfaces offer different ranges, speeds, and energy requirements which can be used optimally depending on the application.

Bluetooth can be used to establish a stable and energy-efficient connection over short distances. This technology is particularly suitable for mobile applications in which the digital key device is coupled, for example, with a smart phone or a portable workshop device. The security of the connection is ensured by modern encryption standards such as Bluetooth Secure Simple Pairing or at LE Secure Connections.

Wi-Fi enables a rapid data transfer over greater distances and is particularly suitable if extensive data such as software updates or diagnosis protocols have to be transferred between the digital key device and the vehicle or a central workshop server. The implementation of WPA3 or similar security standards ensures protected communication in this case.

NFC (Near Field Communication) is optimum for very short ranges and is particularly suitable for the rapid and secure exchange of small amounts of data, such as authentication information or tokens. NFC is extremely secure due to its direct physical proximity and minimizes the risk of eavesdropping or manipulation attempts.

The digital key device is usable in a particularly flexible and versatile manner due to the integration of one or more of these interfaces. The selection of the interface can be oriented here to the specific requirements of the application, such as the required range, the amount of data, or the security requirements. This design not only simplifies the diagnosis and maintenance process, but also permits an integration into modern, networked workshop environments and facilitates the communication with mobile devices, in particular workshop devices, and/or cloud services. The various interfaces therefore offer a high level of flexibility, efficiency, and security in use.

According to a further preferred embodiment, the digital key device can be designed to provide a biometric authentication unit. This means in particular that the authentication takes place not only via digital keys or cryptographic methods, but rather additionally or alternatively biometric features such as fingerprints, facial recognition, and/or iris scans can be used. Such biometric methods offer a particularly high level of security since they are based on unique physical features of the authorized user.

The biometric authentication unit can be integrated technically in the form of sensors or camera modules which capture and process the corresponding features. For example, a fingerprint sensor could be attached to the digital key device, which verifies the user before the release of authorization information. Alternatively, a camera for facial recognition or a special scanner for iris recognition could be used. The captured biometric data are then compared with previously stored reference data, which are stored in the key device or deposited in an encrypted manner.

A further technical possibility is that the biometric data are not stored directly on the key device, but rather instead an encrypted hash function of these data is used to protect the private sphere of the user. This ensures that no sensitive biometric information can be compromised in the event of a potential attack.

The advantage of this embodiment is the enhanced security and user-friendliness. It is ensured by the use of biometric features that only the authorized user receives access to the digital authorization information. This prevents the unauthorized use of the key device even if it is physically stolen. Moreover, the necessity is eliminated of carrying passwords or physical keys, which significantly simplifies the handling in everyday workshop use.

In addition, the supervision and traceability are improved by the biometric authentication, since it can be reconstructed who had access to the vehicle diagnosis or service functions. This function is advantageous especially in security-sensitive areas or in the processing of highly-critical data. Overall, this design offers an effective combination of user comfort, data protection, and security.

According to a further preferred embodiment, the digital key device can comprise a storage medium for storing authentication data. This means in particular that the information required for the authentication, such as digital keys, certificates, tokens, and/or authorization profiles, can be securely stored directly in the digital key device.

The storage medium can be embodied technically as a nonvolatile memory, for example, in the form of a flash memory or EEPROM, in order to preserve the authentication data even in the event of a power loss. Alternatively or additionally, special cryptographic storage solutions could be used, such as secure elements or TPMs (Trusted Platform Modules), which offer a particularly high level of security. Such memories are protected against physical attacks and only allow authorized processes the access to the stored data.

The storage of the authentication data in the digital key device has the advantage that they are locally available and do not have to be retrieved from an external source upon each authentication process. This enables a rapid and independent authentication, in particular in situations in which there is no connection to a network or a central database.

In addition, the storage medium can be designed so that it can be dynamically updated, for example, by over the air updates or via a direct connection to a workshop device. This ensures that new authorization profiles or security certificates can be added or existing ones can be updated as needed, without having to physically exchange the key device.

The advantage of this embodiment is the enhanced security and reliability. Due to the local storage of sensitive authentication data in a specially secured storage medium, the risk of a data loss or unauthorized access is minimized. Moreover, the authentication becomes faster and more efficient, since the data can be processed directly inside the digital key device. This design enables a high level of flexibility in the management of authorization data and contributes to the long-term security and adaptability of the digital key device.

According to a further preferred embodiment, the digital key device can be designed to provide a user interface for the input of authentication information. This means in particular that the user can input the required information, such as passwords, PINs, or other identification data, directly via this interface in order to carry out the authentication of the workshop device.

The user interface can be implemented technically in the form of a physical input device such as a keyboard, a touchscreen, and/or a numeric keypad. Alternatively, it could also represent a virtual interface which is displayed on an external device, such as a smart phone or tablet, when the digital key device is coupled with this device or is integrated in this device, for example, as an app. Additional functions such as haptic feedback or visual confirmations (for example, by LEDs or displays) could further improve the user guidance.

The user interface could be combined with further security functions, such as blocking after a specific number of incorrect inputs or a dynamic request for one-time codes. These measures are used to further enhance the security of the authentication and prevent misuse.

The advantage of this embodiment is the possibility of using the digital key device for a direct and interactive authentication without external devices or additional interfaces being necessary. This makes the handling easy and efficient, especially in workshop environments or other areas of use.

Moreover, the user interface enables a flexible adaptation to various authentication methods. For example, it could support both simple password requests and more complex multifactor authentications. This enhances the security and ensures that the authentication processes can be adapted individually to the requirements of the respective environment.

According to a further preferred embodiment, the digital key device can be designed to provide a mechanism for checking the integrity of the transferred data. This mechanism is used to ensure that the data transferred between the digital key device, the vehicle, and/or the workshop device were not changed or manipulated during the communication process.

The check of the data integrity can be carried out technically by the use of cryptographic hash functions, such as SHA-256 or SHA-3. In this method, a unique hash value is generated for the transferred data and sent together with the data. The same hash value is calculated again on the receiver side and compared to the sent value. If the two correspond, it is ensured that the data have remained unchanged.

In addition, digital signatures could be used, which ensure not only the integrity, but also the authenticity of the data. In this case the hash value is signed using a private key, and the receiver can verify the signature using the corresponding public key.

A further possible approach is the implementation of communication protocols such as TLS (Transport Layer Security), which ensure both the integrity and the encryption of the transferred data. Such protocols could be integrated into the digital key device in order to ensure a continuous protection during the entire communication.

In addition, checking the data integrity offers a higher level of transparency and comprehensibility in the diagnosis and maintenance process, since all participating parties can be secure that the transferred information is correct and trustworthy. This design not only improves the security, but also the trust in the entire system in that it effectively prevents manipulations and ensures the stability of the communication processes.

According to a further preferred embodiment, the USB interface can be designed to provide the access to diagnosis or service functions in the locked and closed state of the vehicle.

The embodiment provides that the external USB interface of the vehicle is designed so that it enables the access to diagnosis or service functions, even if the vehicle is locked and closed. This means in particular that workshop personnel or authorized workshop devices can read out diagnostic data and/or carry out service functions without having to physically unlock or enter the vehicle.

In technical terms this functionality requires a special configuration of the USB interface and the underlying vehicle software. The interface has to be designed so that it permits an access to specific functions in spite of activated security mechanisms in the vehicle, without endangering safety-critical systems or data of the vehicle at the same time. This could be achieved by a partition between the access rights of the USB interface and the main functions of the vehicle, for example, by the implementation of a separate service access mode.

A central component of this embodiment is a strict authentication which ensures that only authorized devices or users receive access to the USB interface. This could be carried out by a digital key device which checks authorizations before it releases the access to diagnosis and service functions. An encryption of the data transfer would additionally ensure that no unauthorized eavesdropping or manipulation attempts are successful.

The advantage of this embodiment is the significant simplification and increase in efficiency of diagnosis and service processes. Workshop personnel no longer have to unlock or open the vehicle, which is advantageous in particular for weather-dependent work or in safety-relevant scenarios. This saves time and reduces the risk of damage to the vehicle due to repeated opening and closing.

In addition, this design offers enhanced security for the vehicle owner, since the physical access to the interior of the vehicle is not required, and therefore the risk of unauthorized access is minimized. At the same time, the private sphere of the vehicle owner is preserved, since no further systems in the interior have to be touched or manipulated. This embodiment therefore combines comfort, security, and efficiency and is particularly suitable for modern workshop environments and vehicle maintenance solutions.

According to a further preferred embodiment, the digital key device can be designed to provide authorization information in a time-limited and/or event-related manner to a workshop infrastructure or a workshop device, in order to enable a restricted maintenance access. This means in particular that the authentication and access rights which are transmitted from the digital key device to a workshop device or workshop infrastructure are specifically restricted to a certain duration or to defined events.

In technical terms, this can be carried out by the generation of temporary tokens or certificates which are only valid within a defined period of time or for a specific number of accesses. For example, the digital key device could generate an authorization token which is valid for the next two hours, or it could allow the access to a diagnosis function only until a specific maintenance order is completed, such as the readout of an error code. Alternatively, the access could be linked to certain conditions, for example, reaching a defined mileage or activating a maintenance mode in the vehicle.

The digital key device could additionally contain mechanisms in order to dynamically revoke or adjust these authorizations. This would be particularly useful if the circumstances change, for example, due to a change of the order given or in the event of a potential security risk. A connection to the cloud or a central management infrastructure could ensure in this case that the authorizations are monitored and controlled in real time.

The advantage of this embodiment is in the enhanced security and flexibility of the maintenance processes. The risk of a misuse is minimized by the chronological or event-related limiting of the authorization information, since access rights expire automatically when they are no longer required. At the same time, this functionality enables a targeted supervision of the type and the scope of the access, which is advantageous in particular in the case of complex maintenance environments or sensitive vehicle data.

This embodiment offers the additional advantage for workshops that they can control the access to vehicle data efficiently and precisely without permanent or comprehensive authorizations being required. This reduces the management effort and ensures that the access to vehicle data always corresponds to the current requirements. Overall, this solution combines security, efficiency, and adaptability and contributes to making the vehicle maintenance more secure and purposeful.

According to a further preferred embodiment, the digital key device can be designed to provide authorization information having a restricted authorization profile, which provides an access to diagnosis and/or software update functions. This means in particular that the authorizations issued by the digital key device deliberately only release those vehicle functions which are required for the intended maintenance or service purpose, while other functions or data remain blocked.

In technical terms, this can be carried out by creating a custom-tailored authorization profile, which precisely defines the scope and the type of the access. This profile could define, for example, that only the access to the error memory of the vehicle or the performance of a specific software update is allowed. Such authorization profiles could be generated and activated by predefined configurations within the digital key device or by instructions from a higher-order infrastructures such as a cloud management platform.

The provision of the restricted profile could be carried out by a combination of a cryptographic method and a specific authorization token, which ensure that only authorized functions are accessible. The digital key device could additionally implement mechanisms in order to monitor the use of the profile and ensure that it is used exclusively in the defined scope.

The advantage of this embodiment is the enhanced security and precision of the access control. The risk of unauthorized or inadvertent changes to critical vehicle systems is minimized by the restriction of the access to specific diagnosis or software update functions. This is particularly important in scenarios in which sensitive vehicle data or security functions are affected.

According to a further preferred embodiment, the digital key device can be designed to provide authorization information which is revocable or changeable at any time. This means in particular that the authorizations issued can be flexibly adapted to control the access to vehicle data or functions in real time, in particular if the requirements or security conditions change.

In technical terms, this functionality can be implemented by the use of dynamic authorization tokens or certificates, which are managed centrally or locally. Such tokens could be provided with a specific runtime, conditions, or access rights which can be modified or revoked at any time by the digital key device. The communication with the digital key device could take place via a secure connection, for example, by encryption or authentication protocols such as TLS.

The digital key device could additionally be connected to a cloud infrastructure and/or a mobile app via which the vehicle owner or an authorized administrator can manage authorizations. This permits access rights to be revoked quickly and in an uncomplicated manner, for example, if a potential misuse is established, or to grant new authorizations if additional maintenance orders are required.

The advantage of this embodiment is the significantly increased flexibility and security of the authorization management. The risk of a misuse is minimized by the possibility of revoking authorizations at any time, even if an authorized device or an authorization is compromised. Authorization profiles can also be dynamically adapted to adapt the access to new requirements or specific maintenance scenarios.

For workshops and vehicle owners, this function offers enhanced control and transparency around the access to the vehicle. In particular, in security-sensitive scenarios or in complex maintenance environments, the possibility of controlling authorizations in real time is a significant advantage. This design contributes to making the maintenance process more secure, efficient, and adaptable, while the risk of incorrect configurations or unauthorized access is reduced at the same time.

According to a further preferred embodiment, the USB interface can be designed as a replacement or supplement to an OBD interface arranged in the vehicle interior. This means in particular that the USB interface is provided as an alternative or additional option in order to access the vehicle diagnosis and service functions.

In technical terms, the USB interface, which is designed in particular as an external USB interface, offers a more modern and flexible alternative to the conventional OBD interface. While the OBD interface is typically based on older communication standards such as ISO 9141 or CAN bus, the USB interface can offer significantly higher data transfer rates and a broader compatibility with modern workshop devices. In addition, the USB interface enables easier access due to its positioning outside the vehicle interior, which substantially simplifies the diagnosis and maintenance process.

As an addition, the USB interface could be used to provide specific functions which are not covered by the OBD interface, such as extensive software updates or data-intensive diagnosis orders. The two interfaces could be operated in parallel in this case, wherein the OBD interface is used for fundamental diagnosis functions and the USB interface is used for advanced orders.

The advantage of the use of the USB interface as a replacement is that it standardizes and modernizes the access to the vehicle diagnosis, while it simultaneously eliminates potential security and access problems due to the central placement of the OBD interface in the interior. As a supplement, it enables greater flexibility in that it provides additional functions without restricting the functionality of the existing OBD interface.

This embodiment offers workshops and vehicle owners a more efficient and user-friendly solution for the maintenance process. The placement of the USB interface outside the interior reduces the effort and possible damage due to repeated opening of the vehicle, while the higher data transfer rate and compatibility with modern devices enable faster and more precise diagnosis and maintenance. This makes this design a practical and future-proof alternative or supplement to the conventional OBD interface.

According to a further preferred embodiment, the external USB interface can be designed to avoid damage to diagnosis cables due to vehicle openings and to provide a continuous workshop operation without keeping vehicle doors or windows open manually. This means in particular that the USB interface is positioned and embodied so that it is easily accessible outside the closed vehicle and no physical barriers due to vehicle parts have to be overcome.

This is achieved in technical terms by the placement of the USB interface at an easily accessible point outside the interior, for example, in the engine compartment, on the bumper, or in an area on the body intended for this purpose. The interface can be made robust in order to keep out environmental influences such as moisture, dirt, or mechanical stresses, and it can be protected by a cover when it is not being used.

Due to this arrangement, the necessity is eliminated of guiding diagnostic tools through open doors or windows, which often has the result that the cables are damaged, in particular if the vehicle is moved during the maintenance. In addition, the level of comfort in the workshop is increased since the workspace around the vehicle is easier to organize and no additional measures are necessary to keep the vehicle open.

The advantage of this embodiment is the significant reduction of cable wear and potential damage to vehicle parts or diagnostic devices. In addition, it contributes to the efficiency of the workshop operation, since work interruptions or refitting times due to open doors or windows are avoided. The security is also improved, since the vehicle can remain in the closed state, which reduces the risk of theft or manipulation during the maintenance.

According to a further preferred embodiment, the digital key device can be designed to provide the authorization information via a secure cloud infrastructure and/or a vehicle owner app to the workshop infrastructure. This means in particular that the authentication and access rights are stored or managed not only locally within the digital key device, but can also be provided via networked systems such as cloud services and/or mobile applications.

In technical terms, the cloud infrastructure could be designed so that it functions as a central node point for the management and distribution of authorization information. In this case, modern encryption standards such as TLS (Transport Layer Security) and end-to-end encryption could be used in order to ensure a secure transfer of the sensitive data. Authorizations could be managed, updated, or revoked in real time via the cloud, which offers a high level of flexibility and adaptability.

The integration of a vehicle owner app enables the vehicle owner to manage access rights directly via a smart phone or another mobile device. The owner could define via a user-friendly interface which workshop or which device receives access to the vehicle data for a certain period of time or for specific tasks. This app could also display authorizations or protocols about the use of the authorizations, which provides additional transparency.

The advantage of this embodiment is the significant improvement of the security and user-friendliness. The use of a secure cloud infrastructure ensures that authorization information is always in the newest state and is protected from unauthorized access. The possibility of managing authorizations via a vehicle owner app offers an intuitive and direct control without physical devices or complex technical processes being required.

For workshops, this design means that they can access authorization information faster and more easily, since this information is provided centrally and securely via the cloud. At the same time, this solution enables a seamless integration into existing workshop management systems. Overall, this embodiment ensures a more efficient and secure service process, in which the control of the access rights remains with the vehicle owner at all times. It combines the advantages of modern networking with high security and convenient operation.

According to a further preferred embodiment, the workshop device can be integrated into the workshop infrastructure, and the digital key device can be designed to provide the authorization information automatically at the vehicle for authentication after the order placement by the vehicle owner. This means in particular that the entire authentication process is substantially automated and is incorporated into the existing workflows of the workshop.

This can be implemented in technical terms by the connection of the workshop device to a central workshop management system, which manages the status of orders and the authorizations. The digital key device could communicate with this system in order to generate authorization information and send it via a secure connection to the vehicle. The communication could take place via a cloud infrastructure, local networks, or direct wired connections, depending on the requirements of the workshop and the vehicle.

After the order placement by the vehicle owner, for example, via a mobile app or an online platform, the digital key device could automatically configure the relevant authorizations. These authorizations could be matched specifically to the scope of the order placed, for example, for diagnostic data, software updates, or specific service functions. As soon as the workshop device is connected to the vehicle, the digital key device provides the authorizations, so that the authentication can be completed without manual intervention.

For vehicle owners, this design offers a simple and secure option for controlling the access to their vehicle. The automatic provision of authorization information after order placement ensures that the access corresponds precisely to the granted authorizations, without the vehicle owner having to actively engage. This function enhances both the comfort and the security of the entire maintenance and diagnosis process in that it enables a precise, rapid, and secure communication between vehicle, workshop, and workshop device.

The present invention will be explained in more detail hereinafter on the basis of the exemplary embodiments indicated in the schematic figures of the drawings.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic block diagram of an embodiment of the vehicle diagnosis and service arrangement according to the invention.

FIG. 2 shows a schematic view of a further embodiment of the vehicle diagnosis and service arrangement according to the invention.

FIG. 3 shows a schematic flow chart of an embodiment of a vehicle diagnosis and service method according to the invention.

FIG. 4 shows a schematic flow chart of a further embodiment of a vehicle diagnosis and service method according to the invention.

### DETAILED DESCRIPTION OF THE DRAWINGS

If reasonable, the described designs and refinements can be combined with one another as desired.

Further possible designs, refinements, and implementations of the invention could also comprise combinations, which are not explicitly mentioned, of features of the invention described above or hereinafter with respect to the exemplary embodiments.

The appended drawings are to convey further comprehension of the embodiments of the invention. They illustrate embodiments and are used in conjunction with the description to explain principles and concepts of the invention.

Other embodiments and many of the mentioned advantages could be obvious in view of the drawings.

The elements of the drawings are not necessarily shown to scale in relation to one another. Identical reference signs designate identical or similarly acting components.

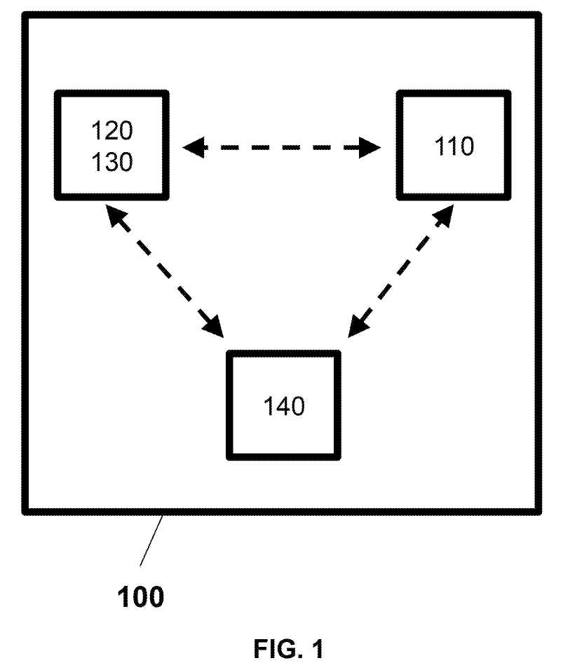

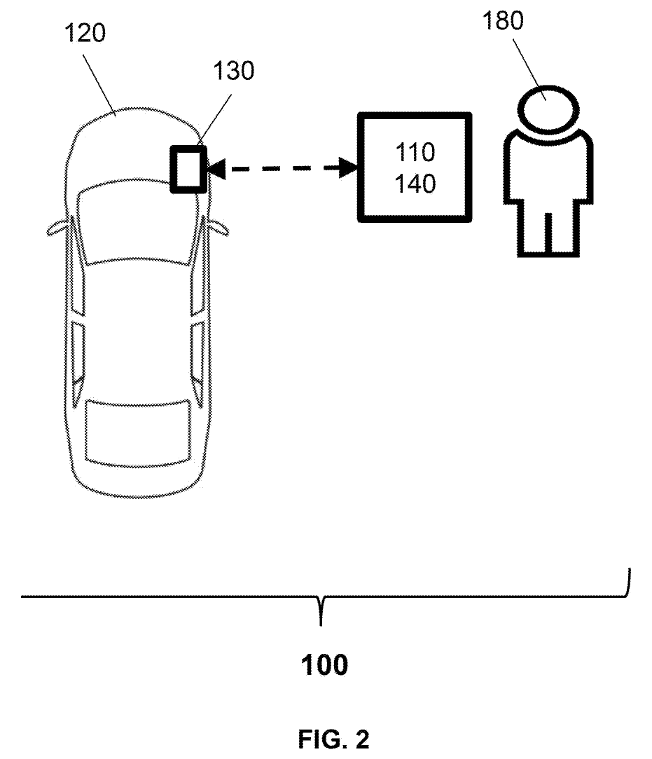

FIG. 1 shows a schematic block diagram of an embodiment of the vehicle diagnosis and service arrangement 100 according to the invention, and FIG. 2 shows a schematic view of a further embodiment of the vehicle diagnosis and service arrangement 100 according to the invention. The vehicle diagnosis and service arrangement 100 comprises a vehicle 120 having a USB interface 130, which is designed to transfer data between the vehicle 120 and a workshop device 110, a workshop device 110, which is designed to be connectable to the USB interface 130 of the vehicle 120, and a digital key device 140, which is designed to authenticate a workshop device 110 connected to the USB interface 130, wherein the vehicle 120 is designed to provide data for diagnosis purposes and/or software updates via the USB interface 130 after successful authentication.

The vehicle diagnosis and service arrangement 100 can comprise the digital key device 140, which provides the authentication of the workshop device 110 using a CCC digital key protocol. Moreover, the USB interface 130 can be designed as a USB-C interface and can provide a maintenance charge of the vehicle battery. Furthermore, the digital key device 140 can be designed as a CCC digital key module and can have a wireless communication interface. The digital key device 140 can additionally provide authentication software and can have a physical interface for connection to an external device. The workshop device 110 can itself comprise a digital key device 140, which provides authorization information for authentication with the vehicle 120. In addition, the digital key device 140 can have an encryption component, which provides the security of the data transfer. The digital key device 140 can be equipped with at least one of the following interfaces: Bluetooth, Wi-Fi, or NFC, and can provide a biometric authentication unit. Moreover, the digital key device 140 can be integrated into the vehicle network and can comprise a storage medium for storing authentication data. In addition, the digital key device 140 can provide a user interface for the input of authentication information and can provide a mechanism for checking the integrity of the transferred data. The external USB interface 130 can provide the access to diagnosis or service functions in the locked and closed state of the vehicle 120. Furthermore, the digital key device 140 can provide authorization information in a time-limited or event-related manner to the workshop infrastructure or the workshop device 110 in order to enable a restricted maintenance access. Moreover, the digital key device 140 can provide authorization information having a restricted authorization profile, which provides an access to diagnosis and/or software update functions. The digital key device 140 can moreover provide authorization information which is revocable or changeable at any time. The USB interface 130 can be designed as a replacement or supplement to an OBD interface arranged in the vehicle interior and can avoid damage to diagnostic cables due to vehicle openings and can provide a continuous workshop operation without keeping vehicle doors or windows open manually. Furthermore, the digital key device 140 can provide authorization information about a secure cloud infrastructure or a vehicle owner app to the workshop infrastructure. Finally, the workshop device 110 can be integrated into the workshop infrastructure and the digital key device 140 can provide the authorization information automatically at the vehicle 120 for authentication after order placement by the vehicle user 180.

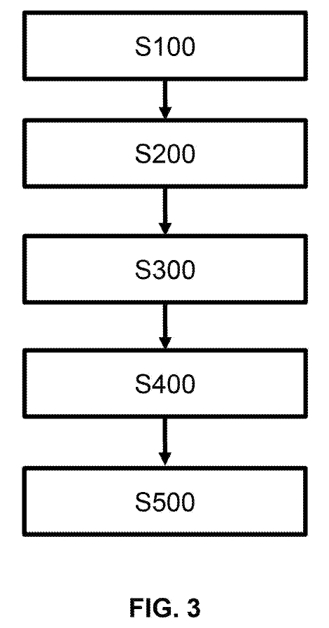

FIG. 3 shows a schematic flow chart of an embodiment of a vehicle diagnosis and service method according to the invention. The vehicle diagnosis and service method for carrying out diagnosis or service orders on a vehicle 120 comprises the following steps:

S100: providing a vehicle 120 having a USB interface 130, which is formed in particular on an outside of the vehicle 120,

S200: connecting a workshop device 110 to the USB interface 130,

S300: authenticating the workshop device 110 connected to the USB interface 130 by means of a digital key device 140,

S400: providing data for diagnostic purposes and/or software updates from the vehicle 120 to the workshop device 110 via the USB interface 130 after successful authentication by means of the digital key device 140.

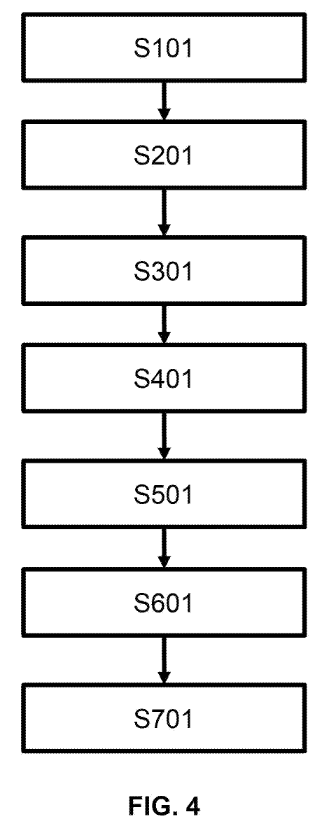

FIG. 4 shows a schematic flow chart of a further embodiment of a vehicle diagnosis and service method according to the invention, which comprises seven method steps S101, S201, S301, S401, S501, S601, and S701.

S101: The vehicle 120 is provided so that it comprises a USB interface 130, which is formed in particular on an outside of the vehicle 120, and which is designed in particular as robust and is located outside the vehicle interior. This USB interface 130 is used as a central communication point and supports modern standards such as USB-C. It is positioned so that workshop personnel do not have to unlock or enter the vehicle 120 for diagnostic purposes. The USB interface 130 is additionally designed so that it is protected against environmental influences such as dust, moisture, and mechanical stresses, for example, by a cover.

S201: A workshop device 110 is physically connected to the USB interface 130 of the vehicle 120. The workshop device 110 is equipped with a USB-C port in order to ensure a rapid and reliable connection. The workshop device 110 can be a diagnostic computer or a software update module which is especially configured for the interaction with the USB interface 130. It has robust plug connections which enable use in demanding workshop environments.

S301: After the physical connection of the workshop device 110, the authentication is carried out with the aid of a digital key device 140. This key device 140 can be embodied as a CCC digital key module and operates, for example, using asymmetrical cryptography. During the authentication process, the digital key device 140 checks the authorizations of the workshop device 110. Secure protocols such as TLS and/or specific standards such as the CCC digital key protocol are used for this purpose. For the authentication, an encrypted key and certificate exchange is carried out to ensure that only authorized devices receive access. Optionally, this process can be supplemented by a wireless connection, for example, via NFC or Bluetooth, if the workshop device 110 has these functionalities.

S401: After successful authentication, the USB interface 130 of the vehicle 120 is unlocked. Data for diagnostic purposes such as error memories and/or sensor data and/or software updates are provided via this interface 130. A special communication module in the vehicle 120 ensures that the data are transferred in a properly formatted protocol, for example, ISO 14229-1 for UDS, to the workshop device 110. The vehicle 120 can additionally carry out a data preparation in order to ensure that only relevant information is released. This protects sensitive vehicle data and enhances the security. The USB interface 130 is configured so that it also enables a maintenance charge of the vehicle battery in order to ensure uninterrupted operation.

S501: During the data transfer, the integrity of the data is ensured by cryptographic mechanisms. Hash functions, such as SHA-256, are used for this purpose in order to ensure that the transferred data have not been changed. An integrated encryption component in the digital key device 140 protects the data from unauthorized access or manipulation. In addition, the workshop device 110 can verify the received data and send feedback to the vehicle 120 in order to confirm the successful transfer. This reduces errors and increases the reliability of the method.

S601: The vehicle 120 only allows the access to previously defined functions, such as diagnosis modes or software updates. These functions are controlled by a restricted authorization profile which is provided by the digital key device 140. This profile can be configured specifically for the current maintenance order and is time-limited in order to prevent misuse. The vehicle 120 can automatically revoke the access rights after completion of the order, by which the security is additionally enhanced.

S701: After completion of the diagnosis or service order, the connection between the workshop device 110 and the USB interface 130 is safely disconnected. The digital key device 140 can store protocol data in order to document the work carried out. These data can be transferred via cloud infrastructure to the vehicle user 180 and/or the workshop infrastructure. Optionally, the vehicle 120 can be put into a secure standby mode in order to ensure that no unauthorized accesses take place after the connection has been disconnected. This step concludes the method and ensures that the vehicle 120 is again completely protected.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### List of reference signs

100 vehicle diagnosis and service arrangement

110 workshop device

120 vehicle

130 USB interface

140 digital key device

180 vehicle user

S100 method step

S200 method step

S300 method step

S400 method step

S101 method step

S201 method step

S301 method step

S401 method step

S501 method step

S601 method step

S701 method step

What is claimed is:

1. A vehicle diagnosis and service arrangement, comprising:
a workshop device; and
a vehicle having a USB interface, which is formed on an outside of the vehicle and is configured to transfer data between the vehicle and the workshop device;
wherein the workshop device is connectable to the USB interface and a digital key device configured to authenticate the workshop device connected to the USB interface;
wherein the vehicle is configured, after successful authentication, to provide data for diagnostic purposes or software updates via the USB interface.

2. The vehicle diagnosis and service arrangement according to claim 1, wherein the digital key device is configured to provide the authentication of the workshop device using a CCC digital key protocol.

3. The vehicle diagnosis and service arrangement according to claim 1, wherein the USB interface is a USB-C interface.

4. The vehicle diagnosis and service arrangement according to claim 2, wherein the USB interface is a USB-C interface.

5. The vehicle diagnosis and service arrangement according to claim 1, wherein the USB interface is configured to provide a maintenance charge of the vehicle battery.

6. The vehicle diagnosis and service arrangement according to claim 2, wherein the USB interface is configured to provide a maintenance charge of the vehicle battery.

7. The vehicle diagnosis and service arrangement according to claim 1, wherein the digital key device is configured as a CCC digital key module.

8. The vehicle diagnosis and service arrangement according to claim 2, wherein the digital key device is configured as a CCC digital key module.

9. The vehicle diagnosis and service arrangement according to claim 1, wherein the digital key device has a wireless communication interface.

10. The vehicle diagnosis and service arrangement according to claim 2, wherein the digital key device has a wireless communication interface.

11. The vehicle diagnosis and service arrangement according to claim 1, wherein the digital key device is configured to provide authentication software.

12. The vehicle diagnosis and service arrangement according to claim 2, wherein the digital key device is configured to provide authentication software.

13. The vehicle diagnosis and service arrangement according to claim 1, wherein the digital key device has a physical interface for connection to an external device.

14. The vehicle diagnosis and service arrangement according to claim 2, wherein the digital key device has a physical interface for connection to an external device.

15. The vehicle diagnosis and service arrangement according to claim 1, wherein the workshop device comprises a digital key device configured to provide authorization information for authentication with the vehicle.

16. The vehicle diagnosis and service arrangement according to claim 2, wherein the workshop device comprises a digital key device configured to provide authorization information for authentication with the vehicle.

17. A vehicle diagnosis and service method for carrying out diagnosis or service orders on a vehicle, the method comprising:
providing a vehicle having a USB interface formed on an outside of the vehicle;
connecting a workshop device to the USB interface;
authenticating the workshop device connected to the USB interface by a digital key device;
providing data for diagnostic purposes or software updates from the vehicle to the workshop device via the USB interface after successful authentication by the digital key device.
